(19) United States
(12) Patent Application Publication
(10) Pub. No.: US 2024/0117891 A1
(43) Pub. Date: Apr. 11, 2024

(54) VALVE FOR THICK MATTER AND METHOD FOR ACTUATING A VALVE FOR THICK MATTER

(71) Applicant: Putzmeister Engineering GmbH, Aichtal (DE)

(72) Inventors: Jens Häfner, Aichtal (DE); Frederik Kort, Aichtal (DE); Ralf Weimer, Aichtal (DE)

(21) Appl. No.: 18/262,090

(22) PCT Filed: Jan. 6, 2022
(86) PCT No.: PCT/EP2022/050180

§ 371 Date: Jul. 19, 2023

(30) Foreign Application Priority Data
Jan. 19, 2021 (DE) 10 2021 100 981.2

(51) Int. Cl. F16K 31/122; E04G 21/04; F04B 7/02; F04B 15/02; F16K 11/072

(52) U.S. Cl. CPC F16K 31/1225; E04G 21/04; F04B 7/02; F04B 15/02; F16K 11/072

(57) ABSTRACT

A valve for thick matter and method for actuating a valve for thick matter, wherein, in a first switching operation, a valve element is switched between a first switching state (A) and a second switching state (B) by a first volume of hydraulic fluid being supplied to a control cylinder, and, in a second switching operation, the valve element is switched between the second switching state (B) and a third switching state (C) by a second volume of hydraulic fluid being supplied to a control cylinder. The first and second volumes of hydraulic fluid are supplied to the control cylinder by displacement of a metering piston of a metering cylinder from a first end position to a second end position.

### BACKGROUND

The invention relates to a thick matter valve and a method for actuating a thick matter valve. The thick matter valve comprises a valve member which can be switched into a first switching state, a second switching state and a third switching state.

The actuation of such a thick matter valve is not very simple since, on the one hand, in order to actuate the thick matter valve high forces have to be applied, whilst, on the other hand, only a brief period of time of significantly less than 1 second is available for the switching operation. Complying with one of the two conditions, that is to say, either high switching forces or a short switching time, is possible with methods known from the prior art. Implementing the combination of both conditions has been found not to be very simple. This is because, in contrast to a thick matter valve having only two positions, it is not possible to use the end positions of a control cylinder as stops.

### SUMMARY

An object of the invention is to provide a thick matter valve and a method so that the thick matter valve can be switched in a rapid and reliable manner between several switching states. The object is achieved with the features of the independent claims. Advantageous exemplary embodiments are set out in the dependent claims.

In the method according to the invention, a valve member is switched between a first switching state and a second switching state by a first volume of hydraulic fluid being supplied to a control cylinder. The valve member is switched between the second switching state and a third switching state by a second volume of hydraulic fluid being supplied to a control cylinder. The first volume of hydraulic fluid is supplied to the control cylinder by a metering piston of a metering cylinder being displaced from a first end position into a second end position. The second volume of hydraulic fluid is supplied to the control cylinder by a metering piston of a metering cylinder being displaced from a first end position into a second end position. The second volume of hydraulic fluid can differ from the first volume of hydraulic fluid. Exemplary embodiments in which the valve member is switched between more than three switching states are also included by the invention.

In order to actuate a switching operation, in the method according to the invention only a single actuation member of a metering cylinder is activated in order to activate the movement of a metering piston in the metering cylinder. Subsequently, the entire volume of hydraulic fluid which the metering cylinder provides with a movement between the first end position and the second end position is supplied to the control cylinder in order to move the valve member into the next switching state. By the metering cylinder providing a defined quantity of hydraulic fluid, a defined state of the control cylinder is directly produced. No feedback in which the state of the control cylinder is measured is required in order to control the metering cylinder depending on the result of the measurement. It is also not necessary to monitor the state of the metering cylinder or to actuate a second actuation member of the metering cylinder in order to bring about the end of the switching operation.

The thick matter valve may have two through-openings with which the valve member cooperates. When the valve member opens a through-opening, thick matter can pass through. In the closed state of a through-opening, no thick matter can pass through. An intermediate state in which the through-opening is partially open can be produced so that a volume of thick matter which is reduced in comparison with the open state can pass through. The thick matter valve can thus be configured in such a manner that it has three switching states, wherein in a first switching state only the first through-opening is open and wherein in another switching state only the second through-opening is open. The thick matter valve may be configured in such a manner that switching is carried out from the first switching state into the second switching state, from the second into the third, from the third into the second and from the second into the first switching state. This switching sequence can be repeated in a cyclical manner.

When the thick matter valve comprises switching operations, in which the valve member is moved in opposing directions, a separate control cylinder may be provided for each of the movement directions. A single control cylinder which controls both movement directions is also possible.

During a switching operation in the context of the invention, a defined volume of hydraulic fluid is conveyed from a metering cylinder to a control cylinder. The volume of hydraulic fluid is measured in such a manner that a control piston which is arranged in the control cylinder is driven in such a manner that the control piston moves the valve member from the first switching position into the second switching position. The method may be carried out in such a manner that the valve member is brought to a standstill at the beginning and at the end of a switching operation. A direct transition between a first switching operation and a second switching operation which follows it immediately so that the valve member is braked with the end of the first switching operation without being brought to a complete standstill and the valve member is accelerated again with the beginning of the next switching operation is also possible.

An end position of the metering piston is determined by means of the configuration of the metering cylinder. The end position is produced in other words not from an actuation member of the metering cylinder being actuated at a specific time in order to interrupt the flow of hydraulic fluid. An end position may, for example, be defined by the piston mechanically striking an element of the metering cylinder. It would also be conceivable, when the end position is reached, for a volume of hydraulic fluid to be enclosed and the metering piston to be brought to a stop in this manner. The end positions of the metering cylinder can be fixedly predetermined. It is also possible for one or more end positions to be able to be changed, wherein the intervention for changing an end position is carried out with a temporal spacing from the end of a switching operation.

It is possible for each of the switching operations of the valve member to be associated with an individual metering cylinder. In the above example with three switching states and four switching operations between the switching states, there are then four metering cylinders, wherein the volume of each metering cylinder corresponds precisely to one of the switching operations. The volume of hydraulic fluid which is provided with the metering cylinders may differ. When the thick matter valve according to the invention comprises a plurality of metering cylinders, they can be in the form of units which are separate from each other. It is also possible to use a hydraulic block, in which a plurality of metering cylinders are formed.

There may be provided a single metering cylinder which is configured to drive different switching operations of the thick matter valve. The volume of hydraulic fluid required for both switching operations may correspond. Between the two switching operations which are driven with this metering cylinder, there may be another switching operation which is driven with another metering cylinder.

A metering cylinder in the context of the invention may be configured in such a manner that only one movement direction of the piston is used in order to drive the control cylinder and the piston is returned to the starting position prior to the next switching operation. It is also possible for the metering cylinder to be configured in such a manner that both movement directions of the piston are used to control the control cylinder. In this instance, the volume of hydraulic fluid conveyed in the two movement directions may be different, as is the case, for example, with a differential cylinder.

In the simplest case, the metering cylinder is configured in such a manner that with a movement between the first end position and the second end position precisely one specific volume of hydraulic fluid is provided. Alternatively, the metering cylinder may be configured to provide a first volume of hydraulic fluid and a different second volume of hydraulic fluid. The metering cylinder may have a first metering piston and a second metering piston. The first metering piston and the second metering piston may be connected to each other by means of a piston rod. With each stroke of the metering cylinder, both the first metering piston and the second metering piston may displace a defined volume of hydraulic fluid. The metering cylinder may be configured in such a manner that the quantities of hydraulic fluid provided do not differ depending on the movement direction of the pistons so that in other words, regardless of the movement direction, with each stroke both the first volume and the second volume are provided. By using such a metering cylinder, depending on the switching operation the control cylinder can be controlled with different quantities of hydraulic fluid.

In one exemplary embodiment, both metering pistons of the metering cylinder have a corresponding cross section. The difference between the first volume and the second volume may arise from the fact that the piston rod is arranged in only one of the two metering chambers. Which of the two metering pistons conveys the larger volume may be dependent on the movement direction of the pistons.

Alternatively, it is also conceivable for a metering cylinder to comprise a plurality of metering pistons, wherein the cross sections of the metering pistons differ from each other. In particular, the metering cylinder may have three metering pistons, of which two have the same cross section and the third has a different cross section. With such a metering cylinder, two different quantities of hydraulic fluid may also be provided with each stroke.

Metering cylinders of this type can be used to control two different switching operations of the valve member. For the first switching operation, the first volume of hydraulic fluid can be supplied to the control cylinder, for the second switching operation, the second volume of hydraulic fluid can be supplied to the control cylinder. It is also possible to use such a metering cylinder in order to control three different switching operations of the valve member. In addition to the two switching operations mentioned above, a third switching operation can be controlled by the sum of the first volume and the second volume being supplied to the control cylinder.

When the metering piston of a metering cylinder moves during a switching operation from the first end position into the second end position, the control piston of the control cylinder is first accelerated and then braked again. During the braking of the control piston, a reduced pressure is produced in the hydraulic fluid in the control cylinder. If the hydraulic fluid withstands the reduced pressure, the actuation cylinder is sufficiently braked in this manner alone. Additional measures to brake the control cylinder are then not necessary.

If the reduced pressure acting on the hydraulic fluid is too great, cavitation may occur so that gas bubbles are formed in the hydraulic fluid. This may result in the actuation cylinder not being braked precisely in the desired position. In order to prevent this, the thick matter valve may be configured in such a manner that the control cylinder is actively braked when approaching a switching position in addition to the reduced pressure between the control piston and the metering cylinder.

The movement with which the valve member is switched between the various switching states may be a pivot movement. The pivot angle for the transition between a first switching state and a second switching state may be between 10° and 30°, preferably between 15° and 25°. The torque to be applied for a switching operation may be greater than 1 kNm, preferably greater than 5 kNm, more preferably greater than 10 kNm. In one exemplary embodiment, the torque to be applied is between 18 kNm and 35 kNm. Higher values of, for example, up to 100 kNm are also possible. The switching time within which a switching operation is carried out may be shorter than 1 second, preferably shorter than 0.5 seconds, more preferably shorter than 0.3 seconds. This may apply to all or to some of the switching operations of the thick matter valve. In one exemplary embodiment, the switching time is between 0.1 and 0.3 seconds. The time period between the end of one switching operation and the beginning of the subsequent switching operation may be shorter than 1 second. These values may apply to some of the switching operations of a thick matter valve or all of the switching operations of a thick matter valve.

The thick matter valve according to the invention can be used in order to control the flow of thick matter in a thick matter pump in which the thick matter is conveyed alternately with two conveying cylinders. A working cycle of the thick material pump may comprise a first portion in which the first conveying cylinder conveys thick matter with a forward movement through an open first through-opening of the thick matter valve, whilst the second conveying cylinder draws thick matter from a store with a backward movement. In a second portion of the working cycle, the first conveying cylinder may further convey thick matter through the open first through-opening with a forward movement, whilst the second through-opening is closed so that the thick matter in the second conveying cylinder can be compressed. In a third phase of the working cycle, the first through-opening and the second through-opening may be open so that the first conveying cylinder and the second conveying cylinder can convey thick matter into the thick matter valve in a parallel manner. In a fourth phase of the working cycle, the second conveying cylinder conveys thick matter with a forward movement through the open second through-opening of the thick matter valve, whilst the first through-opening is released so that the first conveying cylinder can draw thick matter from the store with a backward movement. The working cycle continues by the thick matter being compressed in the second conveying cylinder in a fifth phase and by the first conveying cylinder and the second conveying cylinder conveying thick matter in a parallel manner through the first through-opening and the second through-opening in a sixth phase. Subsequently, the working cycle begins again.

In one exemplary embodiment which is particularly suitable for such a thick matter pump, the valve member has five switching states. In the first switching state, the first through-opening is open and the second through-opening is released toward the thick matter store. In the second switching state, the first through-opening is open and the second through-opening is closed. In the third switching state, the first through-opening and the second through-opening are both open. In the fourth switching state, the second through-opening is open and the first through-opening is released toward the thick matter store. In the fifth switching state, the second through-opening is open and the first through-opening is closed.

The thick matter valve may be configured in such a manner that the volume of hydraulic fluid required for switching from the first switching state into the second switching state is identical to the volume of hydraulic fluid for switching from the fourth switching state into the fifth switching state. The thick matter valve may comprise a metering cylinder by means of which both the transition from the first switching state into the second switching state and the transition from the fourth switching state into the fifth switching state are driven.

The thick matter valve may be configured in such a manner that the volume of hydraulic fluid required for switching from the second switching state into the third switching state is identical to the volume of hydraulic fluid required for switching from the fifth switching state into the third switching state. The thick matter valve may comprise a metering cylinder by means of which both the transition from the second switching state into the third switching state and the transition from the fifth switching state into the third switching state are driven. The volume conveyed with the second metering cylinder may be greater than the volume conveyed with the first metering cylinder. The force required for the transition from the first switching state into the second switching state may be greater than the force required for the transition from the second switching state into the third switching state.

The thick matter valve may be configured in such a manner that the volume of hydraulic fluid required for switching from the third switching state into the fourth switching state is identical to the volume of hydraulic fluid for switching from the third switching state into the first switching state. The thick matter valve may comprise a metering cylinder, by means of which both the transition from the third switching state into the fourth switching state and the transition from the third switching state into the first switching state are driven. The volume conveyed for this switching operation (third switching operation) may be greater than the volume conveyed for the transition from the first switching state to the second switching state (first switching operation) and/or greater than the volume conveyed for the transition from the second switching state to the third switching state (second switching operation).

In one exemplary embodiment, the volume of the third switching operation corresponds to the sum of the volume of the first switching operation and the volume of the second switching operation. The third switching operation may be driven with the same metering cylinder/the same metering cylinders as the first switching operation and the second switching operation.

In one variant, the thick matter valve according to the invention is used to control a pipe switch which is separate from a thick matter pump. The valve member may be configured in such a manner that a first inlet opening and a second inlet opening of the thick matter valve are alternately opened and closed. The pipe switch may have one or more through-openings through which the thick matter is discharged from the thick matter valve again. In the case of a plurality of through-openings, the pipe switch may comprise a second valve member so that a first through-opening and a second through-opening are selectively opened and closed. The second valve member may also be controlled with the method according to the invention. It is also possible for the pipe switch to have two through-openings and for a valve member in the context of the invention to be used in order to switch between the first through-opening and the second through-opening.

The invention further relates to a thick matter valve having a valve member which can be switched between a first switching state, a second switching state and a third switching state. The thick matter valve comprises a control cylinder for actuating the valve member and one or more metering cylinders which have a first end position and a second end position of a metering piston. In order to switch the valve member between the first switching state and the second switching state, a first volume of hydraulic fluid is supplied to the control cylinder by a metering piston being displaced between a first end position and a second end position. In order to switch the valve member between the second switching state and the third switching state, a second volume of hydraulic fluid is supplied to the control cylinder by a metering piston being displaced between a first end position and a second end position.

The invention also relates to a thick matter pump which is provided with a thick matter valve according to the invention. The thick matter pump may comprise two or more than two conveying cylinders. Finally, the invention relates to a pipe switch which is provided with a thick matter valve according to the invention.

The thick matter valve may be developed with additional features which are described in the context of the method according to the invention. The method may be developed with additional features which are described in the context of the thick matter valve according to the invention.

### BRIEF DESCRIPTION OF THE DRAWINGS

The invention is described below by way of example with reference to the appended drawings and advantageous exemplary embodiments. In the drawings:

FIG. 1: shows a vehicle which is provided with a thick matter pump according to the invention;

FIG. 2: shows a schematic illustration of a thick matter pump according to the invention;

FIG. 3: shows a functional drawing of a working cycle of a thick matter pump according to the invention;

FIG. 4: shows a schematic illustration of the control of a thick matter valve according to the invention;

FIG. 5: shows the view from FIG. 4 in an alternative exemplary embodiment of the invention;

FIGS. 6, 7: show exemplary embodiments of metering cylinders for a thick matter valve according to the invention;

FIGS. 8, 9: show schematic illustration of pipe switches according to the invention.

### DETAILED DESCRIPTION

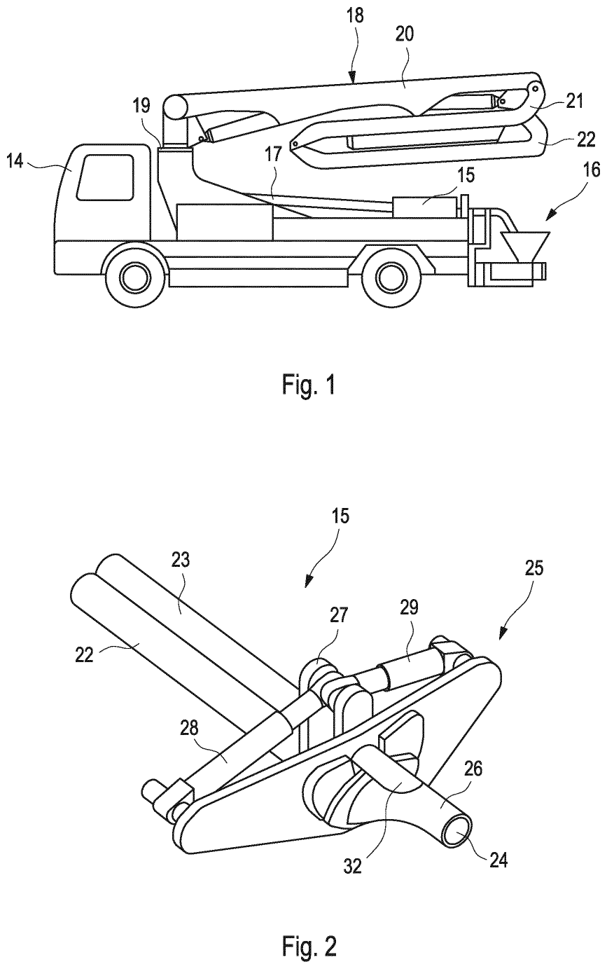

A truck 14 which is shown in FIG. 1 is provided with a concrete pump 5 which conveys liquid concrete from a prefilling container 16 through a conveying line 17. The concrete pump is a thick matter pump 15 in the context of the invention. The conveying line 17 extends along a mast arm 18 which is rotatably supported on a slewing ring 19. The mast arm 18 comprises three mast arm segments 20, 21, 22 which are connected to each other in an articulated manner. By the mast arm segments 20, 21, 22 being pivoted relative to each other via the joints, the mast arm 18 can be displaced between a folded-in state and a folded-out state. The conveying line 17 extends over the distal end of the third mast arm segment 22 so that in the folded-out state of the mast arm 18 the liquid concrete can be discharged in a region remote from the concrete pump 15.

The concrete pump 15 comprises according to FIG. 2 a first conveying cylinder 22 and a second conveying cylinder 23 which in alternating operation draw liquid concrete from the prefilling container 16 and convey it in the direction of a through-opening 24. With a thick matter valve 25 which is arranged between the conveying cylinders 22, 23 and the through-opening 24, the flow of the liquid concrete between the conveying cylinders 22, 23 and the through-opening 24 is controlled. The thick matter valve comprises a valve member 26 which, with respect to a pivot axis 32 is pivotably supported and which can be switched by means of an actuation lever 27 between different switching states. The thick matter valve 25 comprises a first control cylinder 27 and a second control cylinder 28 which act in a hydraulically driven manner on the actuation lever 27.

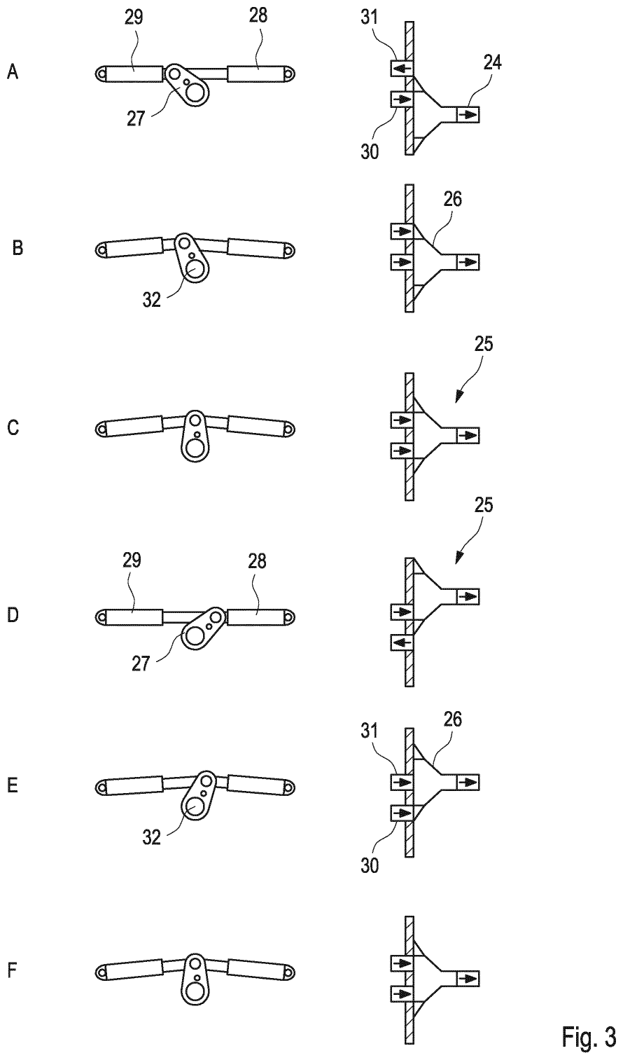

The thick matter valve 25 has according to FIG. 3 a plurality of switching states which during a working cycle of the concrete pump 15 follow each other as follows. In a switching state A, the control cylinder 28 is completely extended and the actuation lever 27 has been moved in a counter-clockwise direction into the outermost position thereof. The valve member 26 opens a first through-opening 20 which is connected to the inner space of the first conveying cylinder 22. The first conveying cylinder 22 conveys in this phase of the working cycle liquid concrete with a forward movement through the first through-opening 30 and the inner space of the valve member 26 to the through-opening 24. The second through-opening 31 is released in the switching state A so that the second conveying cylinder 23 can draw liquid concrete from the prefilling container 16 with a backward movement.

Starting from the switching state A, the thick material valve is switched into the switching state B by the second control cylinder 29 being extended slightly. The actuation lever 27 is pivoted in a clockwise direction into a position which is located between the outer position from switching state A and a central position of the actuation lever 27. The first through-opening 30 remains open so that the first conveying cylinder 22 can continue to convey liquid concrete through the valve member 26. The second through-opening 31 is closed, the second conveying cylinder 23 compresses the liquid concrete in the second conveying cylinder 23 with a forward movement.

Starting from a switching state B, switching is carried out to a switching state C by the second control cylinder 29 being extended further so that the actuation lever 27 is arranged in a central position. The valve member 26 opens the first through-opening 30 and the second through-opening 31 so that both conveying cylinders 22, 23 can convey liquid concrete through the valve member 26 in a parallel manner.

Starting from the switching state C, switching is carried out to a switching state D by the second control cylinder 29 being extended completely, so that the actuation lever 27 is moved into the outermost position thereof when viewed in the clockwise direction. The valve member 26 opens the second through-opening 31 so that the second conveying cylinder 23 can convey liquid concrete through the valve member 26. The first through-opening 30 is released so that the first conveying cylinder 22 can draw liquid concrete from the prefilling container 16 with a backward movement.

Starting from the switching state D, the thick matter valve is switched into the switching state E by the first control cylinder 28 being extended slightly. The actuation lever 27 is pivoted in a counter-clockwise direction into a position which is located between the outer position from the switching state D and a central position of the actuation lever 27. The second through-opening 31 remains open so that the second conveying cylinder 23 can continue to convey liquid concrete through the valve member 26. The first through-opening 30 is closed, the second conveying cylinder 23 compresses the liquid concrete in the first conveying cylinder 22 with a forward movement.

Starting from the switching state E, the thick matter valve is switched into the switching state F by the first control cylinder 28 being extended further so that the actuation lever 27 is arranged in a central position. The valve member 26 opens the first through-opening 30 and the second through-opening 31 so that both conveying cylinders 22, 23 can convey liquid concrete through the valve member 26 in a parallel manner.

Starting from the switching state F, switching is carried out to the switching state A by the first control cylinder 28 being extended completely. A new working cycle of the concrete pump 15 consequently begins.

Between the switching states A and F there is a pivot angle of approximately 80°. The switching operations between the switching states A, B, C and between the switching states D, E, F extend in each case over a pivot angle of approximately 20°. The torque which has to be applied for the switching operations is approximately 30 kNm. A switching time of approximately 0.3 seconds is provided for a switching operation. The dwell time in a switching state prior to the next witching operation is shorter than 1 second.

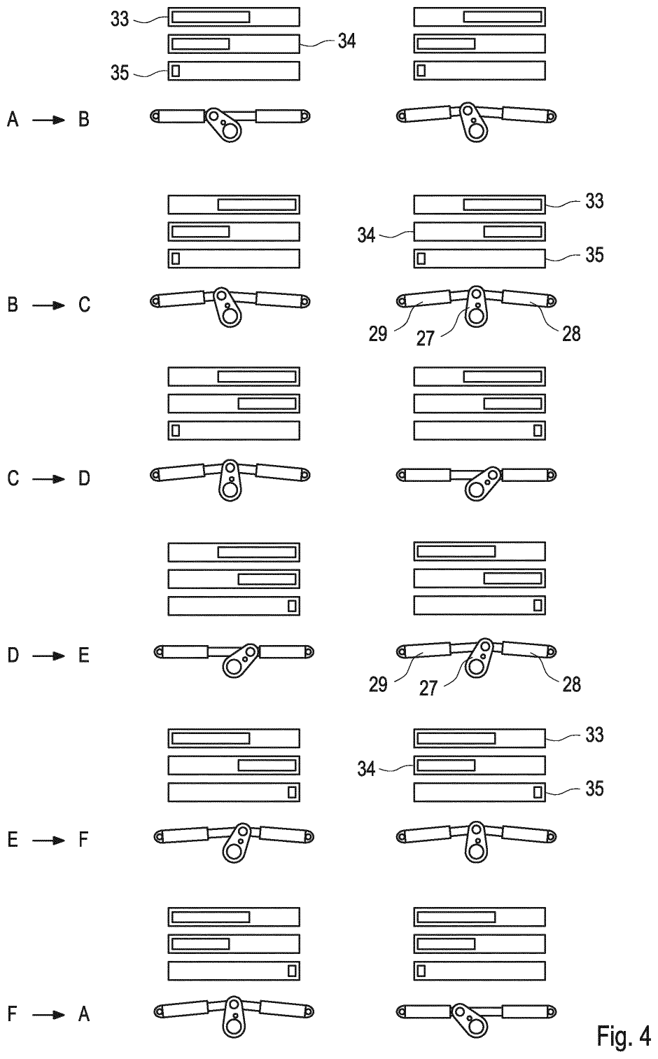

The control of the control cylinders 28, 29 is carried out according to FIG. 4 via a plurality of metering cylinders 33, 34, 35 which are each configured to supply to the control cylinders 28, 29 a defined quantity of hydraulic fluid. For the transition from the switching state A to the switching state B, the first metering cylinder 33 is displaced from a first end position into a second end position, whereby a volume of 440 ml of hydraulic fluid is supplied to the second control cylinder 29. For the transition from the switching state B to the switching state C, the second metering cylinder 34 is actuated, whereby a volume of 530 ml of hydraulic fluid is supplied to the second control cylinder 29. For the transition from the switching state C to the switching state D, the third metering cylinder 35 is actuated, whereby a volume of 970 ml of hydraulic fluid is supplied to the second metering cylinder 29. Accordingly, the transition between the switching states D, E, F is carried out in the opposing rotation direction by the metering cylinders 33, 34, 35 being activated in the opposing direction.

In each of the switching operations, precisely one of the metering cylinders 33, 34, 35 is moved from a first end position into a second end position. This requires in each case the actuation of only a single actuation member of the metering cylinder 33, 34, 35 by means of which the movement of the respective metering piston is initiated, the movement of the metering piston terminates automatically when the second end position is reached without another actuation member having to be actuated and without another control or regulation operation being carried out.

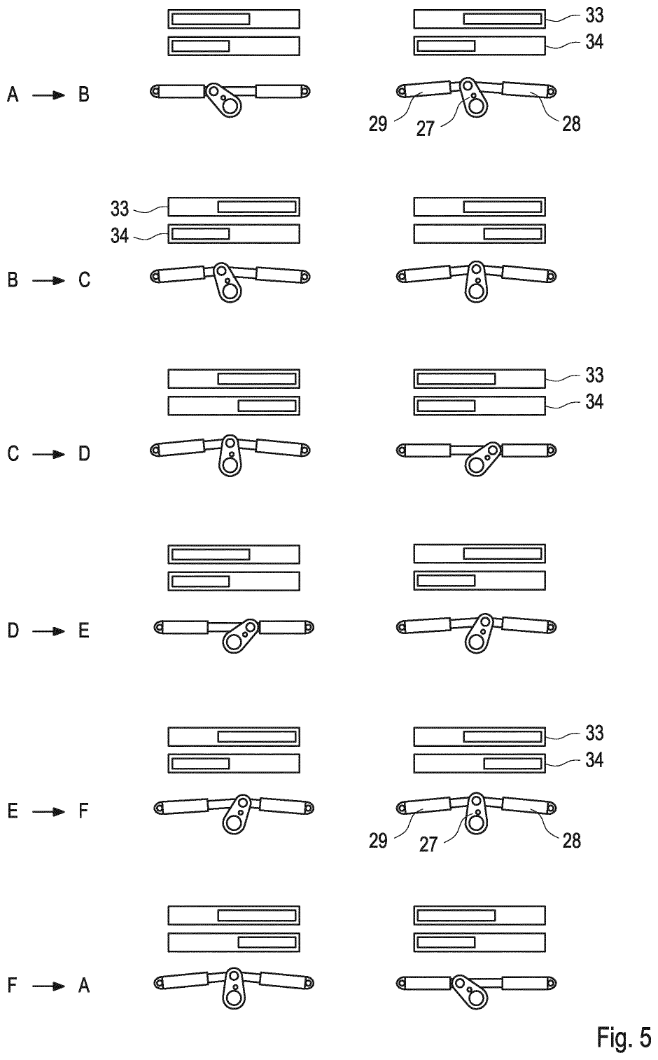

In the alternative exemplary embodiment according to FIG. 5, the control of the control cylinders 28, 29 is carried out with only two metering cylinders 34, 35. For the transition from the switching state A to the switching state B, the first metering cylinder 33 is again activated, for the transition from the switching state B to the switching state C the second metering cylinder 34 is activated. The transition from the switching state C to the switching state D is carried out by both the first metering cylinder 34 and the second metering cylinder 35 being activated. The sum of the volume of the two metering cylinders 34, 35 corresponds to the larger pivot angle which the valve member 26 travels between the switching state C and the switching state D. The switching in the opposite direction is carried out for the transition from the switching state D to E in turn with the first metering cylinder 34, for the transition from the switching state E to the switching state F with the second metering cylinder 35 and from the switching state F to the switching state A with the two metering cylinders 34, 35 together.

The metering cylinders 33, 34, 35 may be components which are separate from each other, with mutually separate cylinders and pistons which are arranged therein. A configuration in the form of a hydraulic block is also possible, wherein a plurality of cylinders are formed in the hydraulic block.

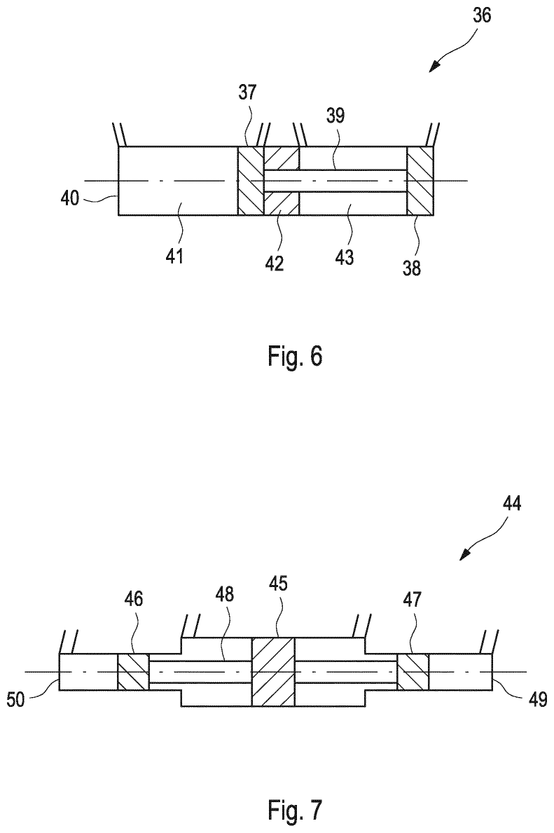

Alternatively, the invention may also be implemented by a single metering cylinder being provided with a plurality of metering chambers. In FIG. 6, a metering cylinder 36 in the form of a differential cylinder is shown. Two pistons 37, 38 which are connected to each other by means of a piston rod 39 are arranged in the metering cylinder 36. Between the first position 37 and an opposing front wall 40, a first metering chamber 41 is enclosed. Between the second piston 38 and a central wall 42, a second metering chamber 43 is enclosed. When the piston is moved out of the right end position shown in FIG. 6 into the left end position, the hydraulic fluid is displaced from both metering chambers 41, 43, wherein the volume in the second metering chamber 43 is smaller than the volume of the first metering chamber 41 as a result of the piston rod 39 which is arranged in the metering chamber 43. When the piston is moved in the opposite direction, the reverse is true. By the control cylinders 28, 29 being connected in an appropriate manner to the first metering chamber 41, to the second metering chamber 43 or to both metering chambers 41, 43 at the same time, all the switching operations shown in FIGS. 4 and 5 can be controlled.

Another exemplary embodiment of a metering cylinder 44 which is suitable for the invention is shown in FIG. 7. The metering cylinder 44 has three pistons 45, 46, 47 of which the central piston 45 has a larger diameter and of which the two outer pistons 46, 47 have a smaller diameter. The three pistons 45, 46, 47 are connected to each other by means of a piston rod 48. In the right end position, the piston 47 abuts the right front wall 49. In the left end position, the piston 46 abuts the left front wall 50. When the pistons 45, 46, 47 are moved from the right end position into the left end position, a first volume of hydraulic fluid is displaced from the outer piston 46 and a second volume of hydraulic fluid is displaced from the central piston 45. This applies accordingly with the reverse movement direction of the pistons 45, 46, 47. By either the volume which is displaced by the outer piston 46, 47 or the volume which is displaced by the central piston 45 or a sum of both volumes being supplied to the control cylinders 28, 29, all the switching operations of the thick matter valve 25 as shown in FIGS. 4 and 5 can be controlled.

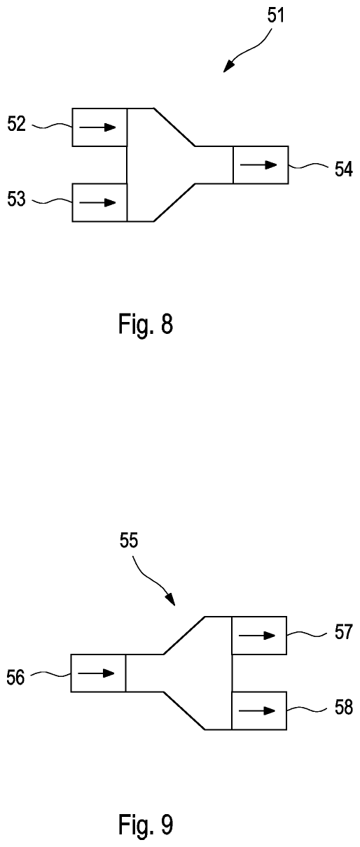

According to FIG. 8, the thick matter valve according to the invention can also be used in the form of a pipe switch 51 which is not a component of a concrete pump. The pipe switch 51 has two inlet openings 52, 53 and a through-opening 54. There is connected in each case to the inlet openings 52, 53 a pipeline (not shown) through which a liquid concrete is conveyed to the pipe switch 51. By switching the thick matter valve, either the liquid concrete coming from the first inlet opening 52 or the liquid concrete coming from the second inlet opening 53 or the liquid concrete coming from the two inlet openings 52, 53 can be directed to the through-opening 54. It is also possible for the thick matter valve according to the invention to be used in a pipe switch 55 which is shown in FIG. 9 and which has an inlet opening 56 and two through-openings 57, 58.

1. A method for actuating a thick matter valve, in which with a first switching operation a valve member (26) is switched between a first switching state (A) and a second switching state (B) by a first volume of hydraulic fluid being supplied to a control cylinder (28, 29), and in which the valve member with a second switching operation is switched between the second switching state (B) and a third switching state (C) by a second volume of hydraulic fluid being supplied to a control cylinder (28, 29), wherein the first volume of hydraulic fluid is supplied to the control cylinder (28, 29) by a metering piston of a metering cylinder (33, 34, 35) being displaced from a first end position into a second end position and wherein the second volume of hydraulic fluid is supplied to the control cylinder (28, 29) by a metering piston of a metering cylinder (33, 34, 35) being displaced from a first end position into a second end position.

2. The method of claim 1, wherein the first switching operation is driven with a first metering cylinder (33) and the second switching operation is driven with a second metering cylinder (34).

3. The method of claim 1, wherein the valve member (26) is switched with a third switching operation between the third switching state (C) and a fourth switching state (D), wherein the volume of hydraulic fluid for the third switching operation corresponds to the sum of the volumes of the first switching operation and the second switching operation.

4. The method of claim 1, wherein a metering cylinder (36, 44) is used in order to drive a first switching operation and a second switching operation.

5. The method of claim 4, wherein the metering cylinder (36, 44) has a plurality of metering pistons (37, 38).

6. The method of claim 5, wherein, for a first switching operation, the volume of hydraulic fluid conveyed with the first metering piston (37) is supplied to the control cylinder (28, 29) and, for a second switching operation, the volume of hydraulic fluid conveyed with the second metering piston (38) is supplied to the control cylinder (28, 29).

7. The method of claim 6, wherein, for a third switching operation, the sum of the volume of hydraulic fluid conveyed with the first metering piston (37) and with the second metering piston (38) is supplied to the control cylinder (28, 29).

8. The method of claim 1, wherein the valve member (26) is activated with a pivot movement and in that the pivot angle for a switching operation is between 10° and 30°.

9. The method of claim 1, wherein, for a switching operation, a torque which is greater than 1 kNm, preferably greater than 5 kNm, more preferably greater than 10 kNm is applied.

10. The method of claim 1, wherein the switching time is shorter than 1 second, preferably shorter than 0.5 seconds, more preferably shorter than 0.3 seconds.

11. A thick matter valve having a valve member (26) which can be switched between a first switching state (A), a second switching state (B) and a third switching state (C), said thick matter valve comprising a control cylinder (28, 29) for actuating the valve member (26) and one or more metering cylinders (33, 34, 35, 36, 44) which have a first end position and a second end position of a metering piston, wherein, to switch the valve member between the first switching state (A) and the second switching state (B), a first volume of hydraulic fluid is supplied to the control cylinder by a metering piston being displaced between a first end position and a second end position, and wherein, to switch the valve member between the second switching state (B) and the third switching state (C), a second volume of hydraulic fluid is supplied to the control cylinder (28, 29) by a metering piston being displaced between a first end position and a second end position.

12. A thick matter pump comprising a first conveying cylinder (22), a second conveying cylinder (23) and a thick matter valve (25) of claim 11, wherein a first inlet opening (30) of the thick matter valve (25) is connected to the first conveying cylinder (22) and a second inlet opening (31) of the thick matter valve (25) is connected to the second conveying cylinder (23).

13. A method for actuating a thick matter valve, said thick matter valve having a valve member connected to a control cylinder responsive to a first volume of hydraulic fluid to move the valve member from a first switching state (A) to a second switching state (B) in a first switching operation and the control cylinder is responsive to a second volume of hydraulic fluid to move the valve member from the second switching state (B) to a third switching state (C) in a second switching operation, said method comprising:
supplying the first volume of hydraulic fluid to the control cylinder by displacing a metering piston of a metering cylinder from a first end position to a second end position; and
supplying the second volume of hydraulic fluid to the control cylinder, wherein supplying the second volume of hydraulic fluid comprises:
displacing the metering piston of the metering cylinder from the first end position to the second end position; or
displacing the metering piston of the metering cylinder from the second end position to the first end position; or
displacing a second metering piston of the metering cylinder from a first end position to a second end position; or
displacing a metering piston of a second metering cylinder from a first end position to a second end position.
